(19) United States
(12) Patent Application Publication
(10) Pub. No.: US 2026/0067272 A1
(43) Pub. Date: Mar. 5, 2026

(54) SECRETS NODE FOR SUPPLYING CREDENTIALS TO OTHER NODES OVER A PRIVATE NETWORK

(71) Applicant: Tailscale Inc., Toronto (CA)

(72) Inventors: David Anderson, Sooke (CA); Michael Fromberger, Seattle, WA (US); Kylie Fisher, Pittsburgh, PA (US)

(21) Appl. No.: 19/317,866

(22) Filed: Sep. 3, 2025

Related U.S. Application Data
(60) Provisional application No. 63/690,201, filed on Sep. 3, 2024.

(51) Int. Cl. H04L 9/40

(52) U.S. Cl. CPC H04L 63/083; H04L 63/205

(57) ABSTRACT

The technology disclosed herein enables a secrets node on a private network to provide credentials to other nodes on the private network. In a particular example, a method includes, in a secrets node, obtaining credentials for accessing a service. The service is provided by one or more computing systems external to the logical network. The method further includes authenticating a client to the logical network and, after authenticating the client, receiving, in the secrets node via the logical network, a request from the client to access the service. The method also includes, in the secrets node, providing the credentials to the client in a response to the request based on the request having been received over the logical network.

### RELATED APPLICATION

This application is related to and claims priority to U.S. Provisional Patent Application 63/690,201, titled “SECRETS NODE FOR ACCESSING EXTERNAL SERVICES FROM WITHIN A PRIVATE NETWORK,” filed September 3, 2024, and which is hereby incorporated by reference in its entirety.

### BACKGROUND

Organizations increasingly rely on external computing services to support a wide range of operational functions, including data processing, storage, analytics, and communication. These services are typically accessed over public or semi-public networks and require secure authentication mechanisms to ensure that only authorized systems can interact with them. As computing environments become more distributed, many enterprises have adopted private overlay networks—such as virtual private networks (VPNs) and mesh-based architectures—to enhance security, simplify connectivity, and enforce identity-based access controls across devices.

Within these private networks, nodes must be authenticated before participating in secure communications. However, the management of authentication credentials for accessing external services presents operational challenges, particularly in environments where nodes dynamically join or leave the network. Conventional approaches often involve manual provisioning or external secrets management platforms that may not align with the trust model or connectivity constraints of the private network. These complexities can affect how credentials are stored, distributed, and rotated across systems operating within such environments.

### SUMMARY

The technology disclosed herein enables a secrets node on a private network to provide credentials to other nodes on the private network. In a particular example, a method includes, in a secrets node, obtaining credentials for accessing a service. The service is provided by one or more computing systems external to the logical network. The method further includes authenticating a client to the logical network and, after authenticating the client, receiving, in the secrets node via the logical network, a request from the client to access the service. The method also includes, in the secrets node, providing the credentials to the client in a response to the request based on the request having been received over the logical network.

In another example, an apparatus is provided having one or more computer readable storage media and a processing system operatively coupled with the one or more computer readable storage media. Program instructions stored on the one or more computer readable storage media, when read and executed by the processing system, direct the apparatus to authenticate the apparatus to the logical network and obtain credentials for accessing a service provided by one or more computing systems external to the logical network. The program instructions further direct the apparatus to receive, via the logical network, a request from a client node to access the service and provide the credentials to the client node over the logical network based the client node being allowed to communicate over the logical network.

In a further example, another apparatus is provided having one or more computer readable storage media and a processing system operatively coupled with the one or more computer readable storage media. Program instructions stored on the one or more computer readable storage media, when read and executed by the processing system, direct the apparatus to join the apparatus to the logical network and determine credentials should be retrieved for accessing a service. The program instructions further direct the apparatus to transmit a request for the credentials over the logical network to a node on the logical network maintaining the credentials for other nodes on the logical network and receive the credentials from the node over the logical network.

### BRIEF DESCRIPTION OF THE DRAWINGS

FIG. 1 illustrates an implementation for accessing credentials from a secrets node on a private network.

FIG. 2 illustrates an operation to access credentials from a secrets node on a private network.

FIG. 3 illustrates an operational scenario for accessing credentials from a secrets node on a private network.

FIG. 4 illustrates an implementation for accessing credentials from a secrets node on a private network.

FIG. 5 illustrates an operation to access credentials from a secrets node on a private network.

FIG. 6 illustrates an operation to access credentials from a secrets node on a private network.

FIG. 7 illustrates an operational scenario for accessing credentials from a secrets node on a private network.

FIG. 8 illustrates an operational scenario for accessing credentials from a secrets node on a private network.

FIG. 9 illustrates an operational scenario for accessing credentials from a secrets node on a private network.

FIG. 10 illustrates an operation to access credentials from a secrets node on a private network.

FIG. 11 illustrates a computing system for accessing credentials from a secrets node on a private network.

### DETAILED DESCRIPTION

Virtual Private Networks (VPNs) work by creating a logical network overlay that allows devices to communicate securely over underlying networks, such as a public or untrusted network (e.g., the Internet). The overlay is achieved through a process called encapsulation, where the data packets sent between devices are wrapped inside additional packets that include encrypted information. For instance, when a VPN endpoint device sends data through a VPN, a packet carrying the data is encrypted and then encapsulated with a new packet header that includes a public IP address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users.

A Tailnet is a VPN created using Tailscale, which leverages the WireGuard protocol to provide secure, encrypted connections between devices. This network allows devices to communicate as if they were on the same local network, regardless of their physical location. Tailscale simplifies network management by eliminating the need for complex configuration or hardware setup, making it accessible for both individuals and organizations.

Nodes in a Tailnet are authenticated using a combination of modern cryptographic techniques and identity verification. Each device that joins a Tailnet must authenticate itself via an identity provider, such as Google, Microsoft, or Okta, which ensures that only nodes associated with authorized users can connect to the Tailnet. The authentication process involves exchanging cryptographic keys to establish trust between devices, ensuring that each node can securely identify and communicate with others within the network.

Once authenticated, each device receives an IP address unique within the VPN and becomes part of the Tailnet. This IP address is used to route traffic securely within the network, and all communication is encrypted using the WireGuard protocol, although, other protocols may be used. Even if devices are on different underlying public networks, their data remains private and secure. Continuous authentication and authorization controls may also be implemented. This means devices are regularly verified and permissions can be adjusted dynamically. If a device’s status changes or if the identity provider's credentials are updated, Tailscale can enforce new access policies in real-time, maintaining the network's security and integrity.

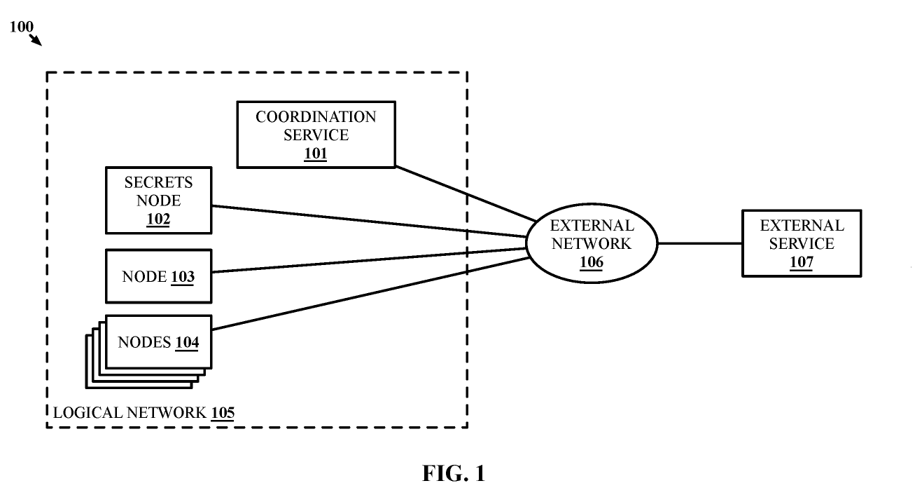

FIGS. 1 illustrates implementation 100 for accessing credentials from a secrets node on a private network. Implementation 100 includes coordination service 101, secrets node 102, node 103, nodes 104, external network 106, and external service 107. Coordination service 101, secrets node 102, node 103, and nodes 104 are all part of logical network 105. Logical network 105 is a private network, such as a VPN/Tailnet, that uses an authentication mechanism to ensure computing devices connected to logical network 105 are authorized to join logical network 105. Logical network 105 is an overlay network on physical networking hardware, such wired/wireless communication links, routers, switches, firewalls, computing devices, or other type of components for providing network communications between computing systems. In some examples, at least a portion of the physical networking hardware is included in, or underlies a portion of, external network 106. External network 106 may include one or more local area networks, wide area networks (e.g., the Internet), or some other type of network. External service 107 provides a computing service over external network 106. External service 107 may provide an application, data storage, or some other type of resource that may be accessible over a network like external network 106. External service 107 may include one or more computing systems, such as servers, to provide the service.

Coordination service 101 a coordination service manages connections and interactions between devices within logical network 105. Coordination service 101 acts as a central authority that facilitates the initial authentication and ongoing management of nodes 103-104. When a device attempts to join logical network 105, the device communicates with coordination service 101 to verify the device’s identity, handle key exchanges, and assign network addresses. Coordination service 101, therefore, ensures only authorized devices can connect and interact with each other over logical network 105 by maintaining an up-to-date directory of valid nodes and their associated credentials. While shown within logical network 105 in this example, coordination service 101 acts as a control plane for logical network 105. Thus, coordination service 101 need not be a node on logical network 105. In fact, coordination service 101 may be external to logical network 105 such that coordination service 101 can coordinate one or more other logical networks in addition to logical network 105.

Beyond authentication, coordination service 101 may also help with routing and maintaining connectivity within logical network 105. Coordination service 101 may track the current network topology and support the dynamic updating of device information, such as IP addresses and connection states. This ensures that devices can efficiently discover and communicate with each other, even as they move between different underlying networks or change their connection statuses. By centralizing these functions, coordination service 101 simplifies network management and enhances the overall security and reliability. Coordination service 101 may be implemented in a single computing device or may be distributed across multiple devices. In some examples, at least a portion of coordination service 101 may be distributed across one or more of nodes 103-104.

In this example, secrets node 102 is a computing node connected to logical network 105 configured to maintain authentication credentials for nodes 103-104 to access external service 107. This functionality of secrets node 102 may be considered like a secrets manager. That is, secrets node 102 may securely store, manage, and access sensitive information such as passwords, passkeys, secure tokens, application programming interface (API) keys, and encryption keys. A secrets manager can provide a centralized, encrypted repository for these secrets, ensuring that they are protected from unauthorized access and leaks. Secrets node 102 may offer features like automated key rotation, access controls, and audit logging to enhance security and compliance. Secrets node 102 may be a distinct computing node on logical network 105 or may be incorporated into one or more of nodes 103-104.

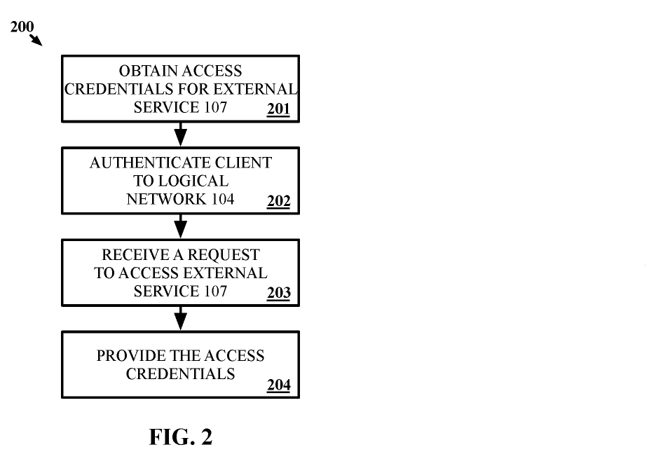

FIG. 2 illustrates operation 200 to for access credentials from a secrets node on a private network. Specifically, operation 200 is an example of how coordination service 101 and secrets node 102 may handle authentication credentials for nodes 103-104 to access external service 107. In some examples, secrets node 102 may maintain authentication credentials for external services in addition to external service 107. In operation 200, secrets node 102 obtains credentials for accessing external service 107 (step 201). The credentials may include a password, passkey, secure token, API key, or encryption key – including combinations thereof. The credentials can be used by nodes 103-104 to access the service provided by external service 107. As such, secrets node 102 stores the credentials to provide to nodes 103-104 upon request. Secrets node 102 may obtain the credentials from a user, such as an administrator of logical network 105, in possession of the credentials, may receive the credentials from one of nodes 103-104, may retrieve the credentials from external service 107, or may obtain the credentials from some other source. In an example where the credentials are retrieved from external service 107, secrets node 102 may first authenticate itself to external service 107 and external service 107 may then provide the access credentials to secrets node 102 (or the access credentials may be obtained in a similar manner from external service 107 by another of nodes 103-104 before providing the credentials to secrets node 102). For instance, secrets node 102 (or other node) may use a username and password to authenticate itself to external service 107 and external service 107 may provide an access token in response.

As noted above, secrets node 102 provides the credentials to nodes 103-104 upon request. If a node has not been authenticated to join logical network 105, secrets node 102 will not trust the node and, accordingly, will not provide the credentials thereto. In some examples, secrets node 102 may not be configured to communicate with systems other than nodes on logical network 105 (e.g., may discard/block packets other than those received over logical network 105). As such, prior to requesting the credentials a node must be authenticated by coordination service 101 and connected to logical network 105. For instance, prior to node 103 requesting credentials to access external service 107, coordination service 101 may authenticate a client executing on node 103 to join node 103 to logical network 105 (step 202). The client is software executing on a computing device implementing node 103 to handle communications exchanged over logical network 105. For example, the client may be charged with encapsulating data packets for transmission to other nodes of nodes 102-104 over logical network 105. After the client authenticates node 103 to exchange communications over nodes 104, coordination service 101 provides information necessary for node 103 to communicate over logical network 105 (e.g., IP addresses, encryption keys, etc.). Secrets node 102, being a node of nodes 102-104, may be authenticated to access logical network 105 using the same mechanism.

After authenticating the client, secrets node 102 receives, via logical network 105, a request from the client of node 103 requesting access external service 107 (step 203). The request may simply indicate that node 103 desires access to external service 107 or may specifically request the credentials for accessing external service 107. Secrets node 102 provides the credentials to the client in response to the request based on the client having been authenticated to logical network 105 (step 204). That is, since secrets node 102 received the request over logical network 105, secrets node 102 recognizes node 103 is part of logical network 105 and is implicitly trusted by secrets node 102 to receive the access credentials for external service 107. Upon receiving the credentials, node 103 may provide the credentials to external service 107 to indicate to external service 107 that node 103 is authorized to access the service. External service 107 may provide the service to node 103 upon authenticating the credentials provided by node 103.

In some examples, the credentials may need to be updated periodically. In those examples, secrets node 102 may ensure the credentials remain up to date (e.g., may periodically communicate with external service 107 to retrieve updated credentials). Secrets node 102 may automatically provide the updated credentials to node 103 or any other node of nodes 103-104 that secrets node 102 provided the credentials to previously or may provide the updated credentials upon request.

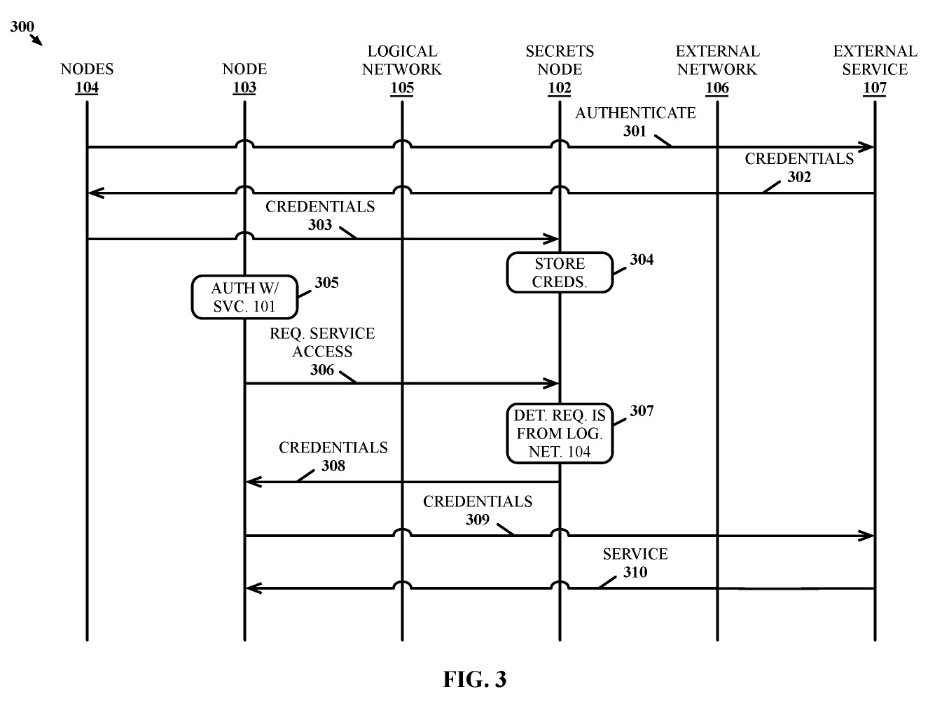

FIG. 3 illustrates operational scenario 300 for accessing credentials from a secrets node on a private network. In operational scenario 300, one of nodes 104 authenticates itself to external service 107 (step 301). During authentication, nodes 104 may provide credentials to external service 107 associated with an account for nodes of logical network 105 to access external service 107. External service 107 may confirm the provided credentials are valid to ensure the requesting node of nodes 104 is able to receive credentials for accessing external service 107. In this example, external service 107 determines the received credentials are valid and provides credentials for nodes to access external service 107 in response (step 302). After receiving the credentials from external service 107, the receiving node of nodes 104 may itself use the credentials to access external service 107 but the node at least sends the credentials to secrets node 102 (step 303).

Secrets node 102 stores the received credentials for use by nodes of logical network 105 (step 304). Secrets node 102 may store the credentials locally to secrets node 102 or may store the credentials in a connected storage system. In some examples, secrets node 102 may cache the credentials on one or more of nodes 103-104. For example, secrets node 102 may include logic for predicting whether a node will request the credentials. The logic may use historical information about a node, or similar nodes, to determine whether the node will request the credentials for accessing external service 107. For instance, if a node requests access to external service 107 every morning, secrets node 102 may cache the credentials at the node prior to a time in the morning when the node historically has requested the credentials from secrets node 102.

In this example, node 103 is connecting to logical network 105 after the credentials have been obtained by secrets node 102. Although, in other examples, node 103 may already be connected to logical network 105 prior to secrets node 102 storing the credentials. To connect to logical network 105, node 103 authenticates itself to coordination service 101 for access to logical network 105 (step 305). Since node 103 is not yet connected to logical network 105, node 103 does not communicate with coordination service 101 over logical network 105. Instead, node 103 may use external network 106, or some other network, to communicate with coordination service 101. In an example, node 103 may be a computer operated by a user associated with logical network 105 (e.g., an employee of a company using logical network 105). The user may input the user’s credentials into node 103 and node 103 may pass those credentials to coordination service 101 to confirm that node 103 is operated by a user authorizing node 103 to access logical network 105. In response to authenticating node 103, coordination service 101 provides information for accessing logical network 105 to node 103. The access information may include identifiers for nodes 102-104, private IP addresses for nodes 102-104 within logical network 105, public IP addresses for nodes 102-104, encryption information (e.g., codecs, keys, etc.), or some other type of information needed to exchange communications over logical network 105.

At a time after receiving the access information for logical network 105, node 103 sends a request for external service 107 to secrets node 102 over logical network 105 (step 306). Since the request is transmitted over logical network 105, the request is transmitted using one or more security protocols employed by logical network 105. For instance, a packet including the request may be encrypted prior to being encapsulated and transmitted to secrets node 102. Secrets node 102 determines encapsulated packed was received over logical network 105 and reverses the security protocols employed by logical network 105 (e.g., decrypts the packet) to read the request (step 307). In some examples, the security protocols may be specific to node 103 (e.g., the decryption key for traffic from node 103 may differ from the keys for traffic from nodes 104). By virtue of the request being received over logical network 105, secrets node 102 provides credentials for accessing external service 107 to node 103 (step 308). Secrets node 102 relies on the security of logical network 105 to assume the request is from an authorized node of logical network 105. Secrets node 102 does not require any authentication beyond what is required to access logical network 105 before providing the credentials.

Upon receiving the credentials from secrets node 102, node 103 uses the credentials to access external service 107 (step 309). The credentials may be provided with an initial request to access the service or may be provided during a handshake process (e.g., external service 107 may request the credentials in response to receiving the initial access request). In an example, the credentials are a secure token. Node 103 may send a copy of the secure token for external service 107 to compare with the token external service 107 provided to coordination service 101. In response to validating the credentials, external service 107 provides the service to node 103 (step 310).

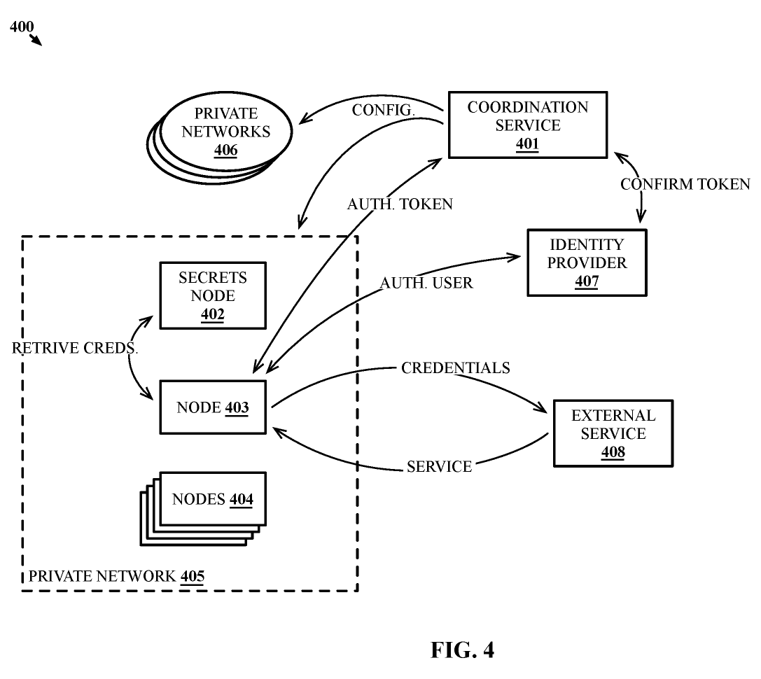

FIG. 4 illustrates implementation 400 for accessing credentials from a secrets node on a private network. Implementation 400 includes coordination service 401, secrets node 402, nodes 403–404, private network 405, private networks 406, identity provider 407, and external service 408. Coordination service 401 is shown external to private network 405 because it is not implemented by a node authenticated to access the data plane of private network 405. Instead, coordination service 401 operates as a control plane for private network 405 and, in this example, also serves as the control plane for one or more additional private networks 406. For instance, coordination service 401 may be provided by a vendor that supplies client software for connecting computing systems to private network 405 as nodes, and may manage authentication, routing, and policy enforcement across multiple networks. Coordination service 401 may maintain a registry of authorized nodes, issue configuration data for secure communication, and facilitate key exchange between nodes. It may also support multi-tenant environments where different private networks are logically isolated but share a common control infrastructure.

Secrets node 402 is shown separately from nodes 403–404 but may be implemented on a computing system similar to those used for nodes 403–404. For example, one of nodes 404 could be tasked with performing the functions of a secrets node in addition to other roles, such as serving applications or handling user traffic. Secrets node 402 may include a secrets module configured to securely store and manage credentials such as API keys, tokens, and certificates. The module may support automated credential rotation, access logging, and policy-based filtering to ensure that only authorized nodes receive specific credentials.

In this example, identity provider 407 is used to authenticate user credentials for computing systems attempting to connect as nodes to private network 405. Identity provider 407 may also be used to authenticate nodes in private networks 406, although those networks may alternatively rely on different identity providers or security mechanisms. Identity provider 407 may implement protocols such as OAuth 2.0, OpenID Connect, or SAML, and may support multi-factor authentication (MFA), biometric verification, or hardware-backed credentials. Authentication may be performed on behalf of human users, service accounts, or automated agents.

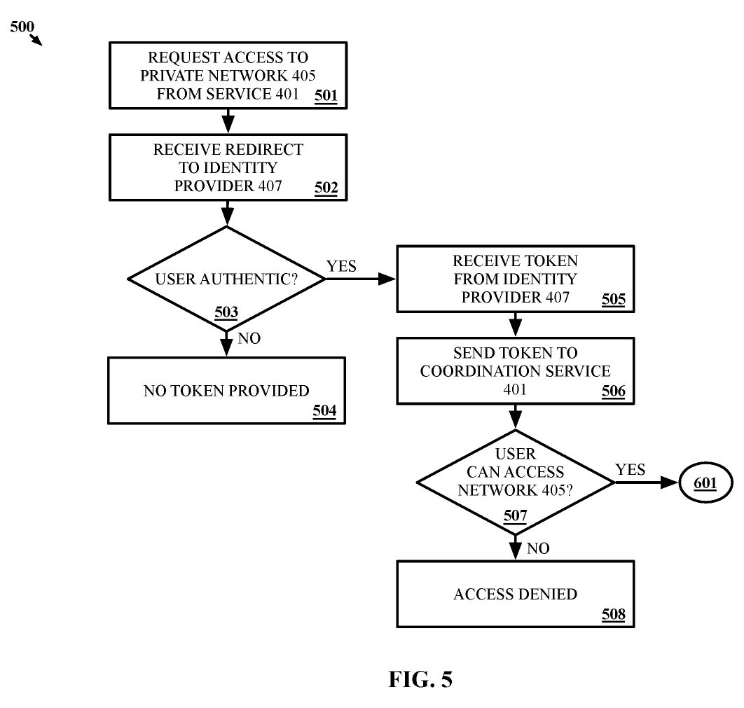

FIG. 5 illustrates operation 500 to access credentials from a secrets node on a private network. Operation 500 shows how a computing system (e.g., laptop, smartphone, server, etc.) joins private network 405 and receives credentials from secrets node 402. For simplicity, the computing system is referred to as node 403 even before it is formally admitted to private network 405. In step 501, node 403 requests to join private network 405 by sending a request to coordination service 401. The public IP address of coordination service 401 may be predefined in a client application, obtained via a DNS lookup, or discovered through other mechanisms such as service advertisements or configuration files. The request may include metadata such as device identifiers, software version, and geolocation data, which coordination service 401 may use to evaluate the authenticity and compliance of node 403.

In response, coordination service 401 sends a redirect message instructing node 403 to contact identity provider 407 for authentication (step 502). Node 403 follows the redirect and exchanges information with identity provider 407 to authenticate itself (step 503). This exchange may involve user credentials such as usernames and passwords, passkeys, or other identifying information. The user may be a human operator, a software agent, or a hardware component authorized to access private network 405. Authentication may be performed using a federated identity model, allowing users from different domains or organizations to access shared infrastructure. The identity provider may issue a signed token (e.g., JWT) that encodes user attributes and access claims.

If identity provider 407 is unable to authenticate the user, it does not issue a secure token to node 403 (step 504). If authentication succeeds, node 403 receives a secure token from identity provider 407 (step 505). Node 403 then presents the token to coordination service 401 (step 506), which may verify the token’s signature and optionally query identity provider 407 for additional user attributes. These attributes may include the user’s name, role, department, office location, or other metadata relevant to access control. Coordination service 401 may use this information to evaluate policy rules that govern access to private network 405. These rules may be expressed in formats such as JSON-based ACLs or policy-as-code frameworks.

At step 507, coordination service 401 determines whether the user is authorized to access private network 405. If not, node 403 is denied access (step 508), and no network configuration is provided. Denial may be logged for audit purposes and may trigger alerts or remediation workflows. In some implementations, coordination service 401 may provide feedback to the user or administrator indicating the reason for denial. If the user is authorized, operation 500 continues at step 601 of operation 600.

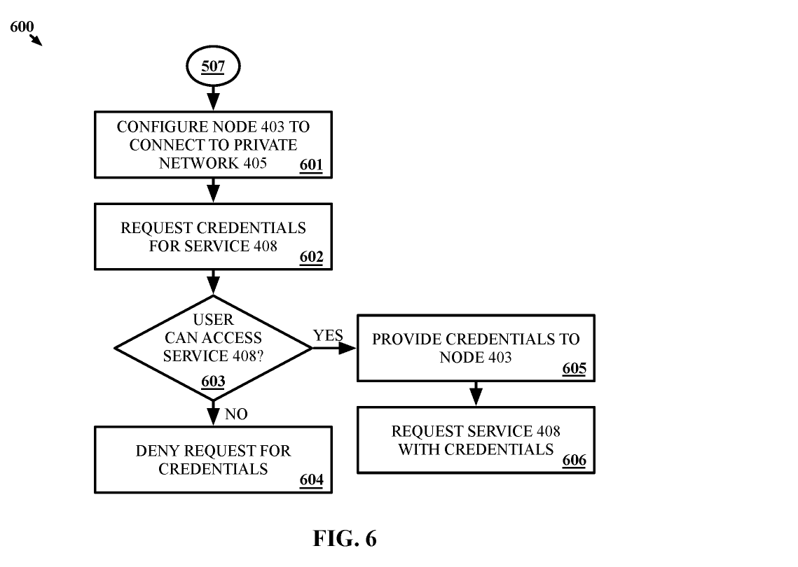

FIG. 6 illustrates operation 600 to access credentials from a secrets node on a private network. Operation 600 continues from operation 500 after coordination service 401 has determined that the user of node 403 is authorized to access private network 405. In operation 600, coordination service 401 configures node 403 to connect to private network 405 (step 601). Configuring node 403 may include providing private IP addresses for other nodes (e.g., nodes 404) on private network 405, public IP addresses for those nodes on a public network, encryption information (e.g., encryption keys, schemes, etc.) for securely encrypting communications over private network 405, network policies for private network 405, or any other information node 403 may use to communicate over private network 405. This configuration may be transmitted as a signed payload or certificate bundle, and may include time-bound access tokens, routing tables, and protocol-specific parameters (e.g., WireGuard peer configurations). Coordination service 401 may also configure other nodes on private network 405 to communicate with node 403 by sending node 403’s private/public IP addresses, encryption information, policy updates, or other relevant data to those nodes. In some implementations, coordination service 401 may perform mutual configuration updates to ensure bidirectional trust and compatibility between nodes.

At some point after node 403 is joined to private network 405, node 403 requests credentials stored at secrets node 402 (step 602). In this example, the credentials enable node 403 to access external service 408, but they may also include other types of credentials or secure information stored at secrets node 402. Examples of secure information include database passwords, SSH keys, TLS certificates, or OAuth tokens. The request may be initiated by a user, a scheduled task, or an application running on node 403. The request may be formatted as an API call to an API provided by secrets node 402 for accessing information stored thereat.

In some examples, the mere fact that node 403 is a member of private network 405 may be sufficient for secrets node 402 to comply with the request. However, in this example, a further determination is made as to whether the user of node 403 is permitted to access external service 408 (step 603). For instance, policies may specify which users or nodes are allowed to access certain credentials stored in secrets node 402. The request may include information about the user of node 403 to which the policies can be applied, or secrets node 402 may retrieve that information independently.

User information may be encoded in the request as a signed token, or inferred from the source IP address, cryptographic identity, or session metadata. In an example of the latter, coordination service 401 may provide user information about users of nodes 403–404, and secrets node 402 may recognize node 403 from the source address of the request and/or an encryption key associated with node 403 used to encrypt the request. Secrets node 402 may then reference information from coordination service 401 identifying the user of node 403. This lookup may involve querying a local cache, a distributed directory, or an external identity provider.

If the user is not permitted to access external service 408, secrets node 402 denies the request for credentials (step 604). Denial may be accompanied by a structured error message or audit log entry and may trigger alerts or access review workflows. If the user is permitted, secrets node 402 provides the credentials by sending them over private network 405 to node 403 (step 605). The credentials may be encrypted in transit using session-specific keys or end-to-end encryption protocols. Node 403 then supplies the credentials to external service 408 when requesting service therefrom (step 606). This may involve presenting the credentials in an API request, TLS handshake, or other authentication mechanism supported by external service 408.

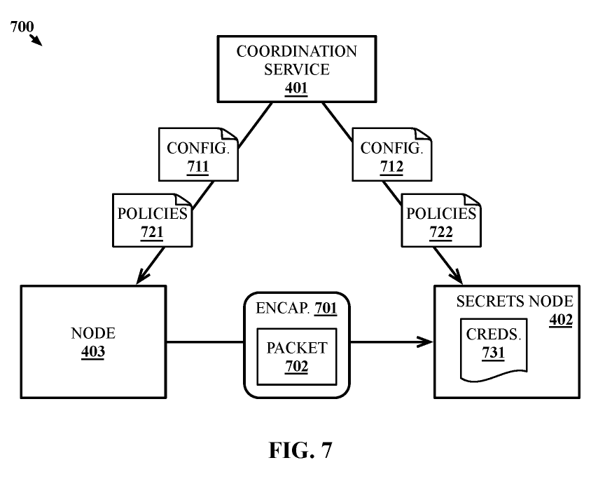

FIG. 7 illustrates operational scenario 700 for accessing credentials from a secrets node on a private network. Operational scenario 700 shows how a request for credentials may be sent to secrets node 402 over private network 405. Coordination service 401 sends network configuration information 711 and network policies 721 to node 403. Coordination service 401 also sends network configuration information 712 and network policies 722 to secrets node 402. These policies may be expressed in declarative formats such as JSON, YAML, or HuJSON, and may include role-based access rules, time-based restrictions, and service-specific permissions. Network configuration information 711 and 712 may include the same communication parameters if, for instance, node 403 and secrets node 402 have identical access permissions for communicating over private network 405. If node 403 and secrets node 402 have different access permissions, coordination service 401 may provide distinct configuration data to each. For example, node 403 may be permitted to access all of nodes 404, while secrets node 402 may be restricted to communicating only with a subset of nodes 403-404. As such, network configuration information 711 may include network information about a node of nodes 404 that node 403 can access, while network configuration information 712 omits that information if secrets node 402 cannot access the node. This selective configuration helps enforce network segmentation and minimizes the attack surface by limiting unnecessary connectivity.

Secrets node 402 stores credentials 731, which are the credentials that node 403 will use to access external service 408. Secrets node 402 may also store other credentials or secure information for ease of access over private network 405. Storage may be implemented using encrypted databases, hardware security modules (HSMs), or secure enclaves. Credentials may be versioned, tagged, and associated with metadata such as expiration time, access history, and usage scope. Secrets node 402 may store different information for different users of private network 405, may store information that can be accessed by multiple users (e.g., users in a particular role), or may implement other mechanisms for separating stored information. Access control may be enforced using grants, ACLs, capability tokens, or policy engines that evaluate contextual attributes such as user identity, device posture, and request origin.

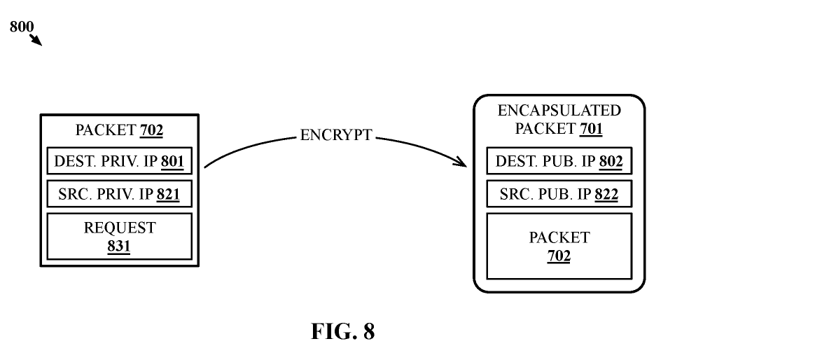

FIG. 8 illustrates operational scenario 800 for accessing credentials from a secrets node on a private network. Operational scenario 800 shows how secrets node 402 can rely on node 403’s network access to determine whether node 403 is authorized to access credentials 731. A requesting application—such as a client application operated by the user to access secure information stored on secrets node 402—executes on node 403 and generates credential request 831 for credentials 731. The application creates packet 702 with credential request 831 as its payload. Packet 702 is intended for transmission over private network 405 to secrets node 402 and therefore includes destination private IP address 801 of secrets node 402 as the destination address and source private IP address 821 of node 403 as the source address. These private IP addresses are assigned by coordination service 401 and may be unique within private network 405. They serve as identifiers for routing and access control within private network 405.

Since private network 405 is a logical overlay network, node 403 encapsulates packet 702 for transmission over the underlying physical network. In this example, encapsulation includes encrypting packet 702 using a public key associated with secrets node 402. The resulting encapsulated packet 701 includes the encrypted version of packet 702 as its payload and is addressed to destination public IP address 802 of secrets node 402, with source public IP address 822 of node 403 as the source. Encapsulation may follow protocols such as WireGuard, IPsec, or GRE, and encryption may use asymmetric cryptography (e.g., RSA or ECC) to ensure confidentiality and authenticity. The encapsulation may be performed by a client application that connects node 403 to private network 405 or by another component of node 403, such as a network interface or operating system module. The public key, along with the private and corresponding public IP addresses, may be provided to node 403 in network configuration information 711. This configuration may also include session keys, certificate chains, and policy metadata to support secure communication and access control.

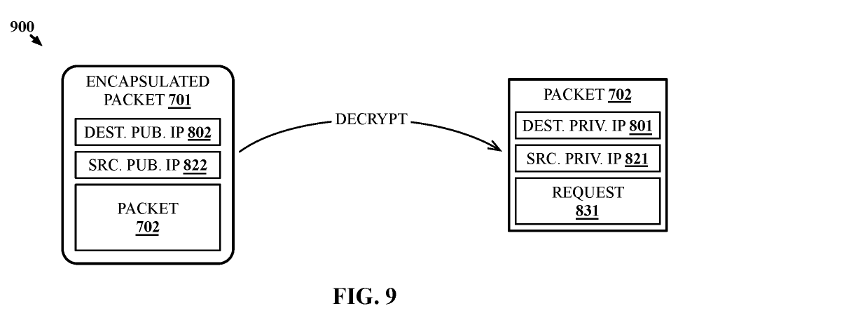

FIG. 9 illustrates operational scenario 900 for accessing credentials from a secrets node on a private network. Operational scenario 900 shows what occurs at secrets node 402 upon receiving encapsulated packet 701. Secrets node 402 decrypts packet 702 using a private key that corresponds to the public key used by node 403 to encrypt the packet. Decryption may involve verifying the integrity of the packet, checking its timestamp, and validating its origin using cryptographic signatures. Secrets node 402 recognizes source public IP address 822 as belonging to node 403, either directly or by cross-referencing source private IP address 821. This recognition may be based on a mapping maintained in network configuration information 712, which associates IP addresses with node identities and user attributes. Coordination service 401 may have previously provided this mapping, allowing secrets node 402 to identify the requesting node and its associated user.

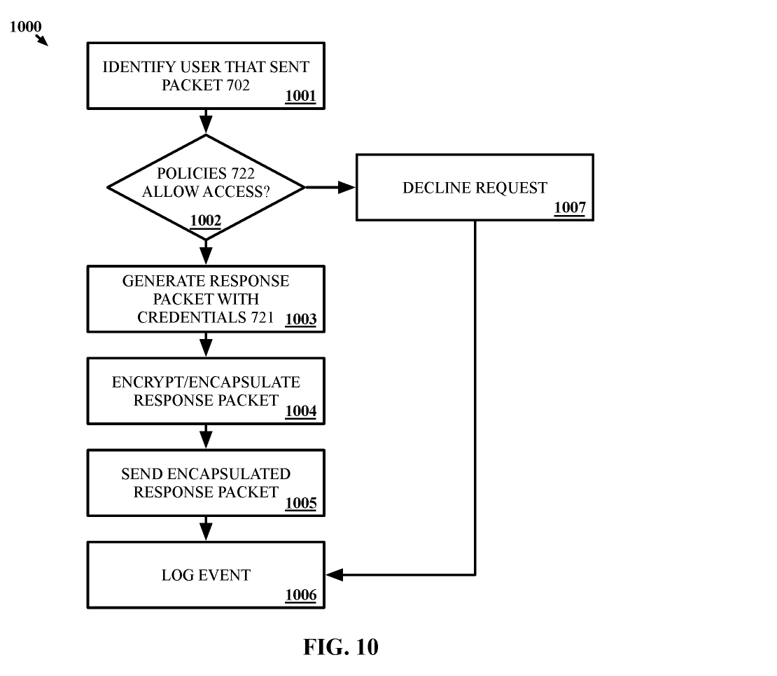

FIG. 10 illustrates operation 1000 to access credentials from a secrets node on a private network. In some examples, the fact that node 403 sent credential request 831 over private network 405 using encapsulated packet 701 may be sufficient for secrets node 402 to comply with the request. However, in this case, secrets node 402 has received network policies 722 from coordination service 401 that define more granular rules for determining which nodes or users may access specific secret information stored on secrets node 402. Operation 1000 begins with secrets node 402 determining the user of node 403 that sent packet 702 (step 1001). This determination may rely on metadata in the packet, such as a signed token, or on IP address mappings provided in network configuration information 712. For example, network configuration information 712 may indicate that source private IP address 821 is associated with a particular user.

Secrets node 402 then evaluates whether network policies 722 permit the user to access credentials 731 (step 1002). Policies may include role-based access control (RBAC), attribute-based access control (ABAC), or custom rules defined by administrators. Evaluation may involve checking user roles, group memberships, device posture, or time-of-day constraints. If network policies 722 permit access, secrets node 402 generates a response packet to node 403 that includes credentials 731 in its payload (step 1003). The response packet uses source private IP address 821 as the destination and destination private IP address 801 as the source. Secrets node 402 encrypts the response packet using a public key associated with node 403 and encapsulates it in a packet addressed to source public IP address 822, with destination public IP address 802 as the source (step 1004). This ensures that only node 403 can decrypt and use the credentials, preserving confidentiality and integrity. The public key may have been received earlier in network configuration information 712. Secrets node 402 sends the encapsulated response packet to source public IP address 822 over the underlying network (step 1005).

If the user of node 403 is not permitted to access external service 408, secrets node 402 does not supply credentials 731 in a response packet (step 1007). For example, network policies 722 may lack a rule granting access to the user or may explicitly deny access based on user attributes or request context. In some cases, network policies 721 received by node 403 may also lack such a rule, preventing the request from being generated or sent in the first place.

Regardless of whether credentials 731 are provided, secrets node 402 logs the event (step 1006). The log entry may include a timestamp, user identity, node identifier, requested credentials, request outcome, and other metadata relevant to auditing and compliance. Logs may be stored locally, forwarded to a centralized logging service, or integrated with security information and event management (SIEM) systems.

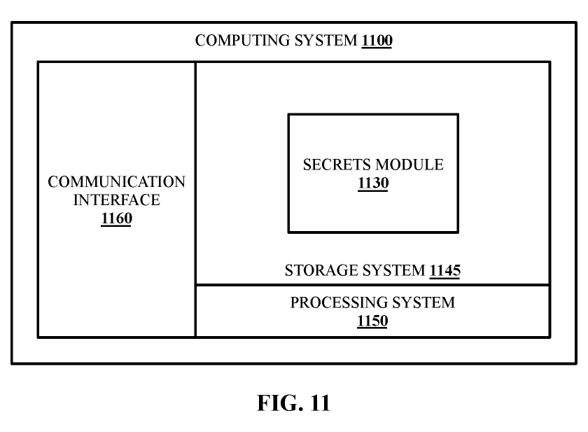

FIG. 11 illustrates computing system 1100 for accessing credentials from a secrets node on a private network. Computing system 1100 is representative of any computing system or systems with which the various operational architectures, processes, scenarios, and sequences disclosed herein can be implemented. Computing system 1100 is an example architecture for coordination service 101, nodes 103-104, and external service 107, although other examples may exist. Computing system 1100 includes storage system 1145, processing system 1150, and communication interface 1160. Processing system 1150 is operatively linked to communication interface 1160 and storage system 1145. Communication interface 1160 may be communicatively linked to storage system 1145 in some implementations. Computing system 1100 may further include other components such as a battery and enclosure that are not shown for clarity.

Communication interface 1160 comprises components that communicate over communication links, such as network cards, ports, radio frequency (RF), processing circuitry and software, or some other communication devices. Communication interface 1160 may be configured to communicate over metallic, wireless, or optical links. Communication interface 1160 may be configured to use Time Division Multiplex (TDM), Internet Protocol (IP), Ethernet, optical networking, wireless protocols, communication signaling, or some other communication format – including combinations thereof. Communication interface 1160 may be configured to communicate with other computing systems via one or more networks.

Processing system 1150 comprises microprocessor and other circuitry that retrieves and executes operating software from storage system 1145. Storage system 1145 may include volatile and nonvolatile, removable, and non-removable media implemented in any method or technology for storage of information, such as computer readable instructions, data structures, program modules, or other data. Storage system 1145 may be implemented as a single storage device but may also be implemented across multiple storage devices or sub-systems. Storage system 1145 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 1145, or any other computer-readable storage medium herein, be considered a transitory form of signal transmission (often referred to as "signals per se"), such as a propagating electrical or electromagnetic signal or carrier wave.

Processing system 1150 is typically mounted on a circuit board that may also hold the storage system. The operating software of storage system 1145 comprises computer programs, firmware, or some other form of machine-readable program instructions. The operating software of storage system 1145 comprises secrets module 1130. The operating software on storage system 1145 may further include an operating system, utilities, drivers, network interfaces, applications, or some other type of software. When read and executed by processing system 1150 the operating software on storage system 1145 directs computing system 1100 to network routing advertisements as described herein. Secrets module 1130 may execute natively on processing system 1150 or the operating software may include virtualization software, such as a hypervisor, to virtualize computing hardware on which secrets module 1130 executes.

In at least one example, secrets module 1130 executes on processing system 1150 and directs processing system 1150 to obtain credentials for accessing a service. The service is provided by one or more computing systems external to the logical network. Secrets module 1130 further directs processing system 1150 to authenticate computing system 1100 to the logical network and, after authenticating, receive, via the logical network, a request from another node on the logical network to access the service. Secrets module 1130 also directs processing system 1150 to provide the credentials to the other node in response to the request based on the other node having been authenticated to the logical network.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for managing credentials for services external to a logical network, the method comprising:
in a secrets node, obtaining credentials for accessing a service, wherein the service is provided by one or more computing systems external to the logical network;
authenticating a client to the logical network;
after authenticating the client, receiving, in the secrets node via the logical network, a request from the client to access the service; and
in the secrets node, providing the credentials to the client in a response to the request based on the request having been received over the logical network.

2. The method of claim 1, wherein the credentials comprise at least one of: a password, passkey, secure token, API key, or encryption key.

3. The method of claim 1, wherein obtaining the credentials comprises:
receiving the credentials from an administrator of the logical network.

4. The method of claim 1, wherein obtaining the credentials comprises:
authenticating the secrets node to the service.

5. The method of claim 1, comprising:
after obtaining the credentials, obtaining updated credentials from the service.

6. The method of claim 1, wherein receiving the request comprises:
receiving one or more encapsulated packets over a public network; and
de-encapsulating the one or more encapsulated packets to obtain the request therein.

7. The method of claim 6, wherein de-encapsulating the one or more encapsulated packets comprises:
decrypting the one or more encapsulated packets using a private key, wherein the client encrypted the one or more encapsulated packets using a public key corresponding to the private key.

8. The method of claim 1, wherein the client caches the credentials prior to when the service will be accessed in accordance with historical access patterns.

9. The method of claim 1, comprising:
discarding a second request not received via the logical network.

10. The method of claim 1, comprising:
providing the credentials after determining access control policies of the logical network allow the client to access the service.

11. An apparatus for managing secrets in a logical network, the apparatus comprising:
one or more computer readable storage media;
a processing system operatively coupled with the one or more computer readable storage media; and
program instructions stored on the one or more computer readable storage media that, when read and executed by the processing system, direct the apparatus to:
authenticate the apparatus to the logical network;
obtain credentials for accessing a service provided by one or more computing systems external to the logical network;
receive, via the logical network, a request from a client node to access the service; and
provide the credentials to the client node over the logical network based the client node being allowed to communicate over the logical network.

12. The apparatus of claim 11, wherein to obtain the credentials, the program instructions direct the apparatus to:
authenticate the apparatus to access the service.

13. The apparatus of claim 11, wherein the program instructions direct the apparatus to:
retrieve updates to the credentials.

14. The apparatus of claim 11, wherein the program instructions direct the apparatus to:
identify a user of the client node; and
before the credentials are provided to the client node, determine access control policies of the logical network allow the user to access the service.

15. The apparatus of claim 14, wherein to identify the user, the program instructions direct the processing system to:
receive an identity of the user corresponding to the client node from a coordination service for the logical network, wherein the coordination service also supplies the access control policies.

16. The apparatus of claim 11, wherein to receive the request, the program instructions direct the apparatus to:
receiving one or more encapsulated packets directed to a public network address of the apparatus over a public network; and
de-encapsulating the one or more encapsulated packets to obtain the request therein addressed to a private network address of the apparatus.

17. The apparatus of claim 11, wherein the program instructions direct the apparatus to:
create an entry for the request in a log of credential access events.

18. An apparatus for managing secrets in a logical network, the apparatus comprising:
one or more computer readable storage media;
a processing system operatively coupled with the one or more computer readable storage media; and
program instructions stored on the one or more computer readable storage media that, when read and executed by the processing system, direct the apparatus to:
join the apparatus to the logical network;
determine credentials should be retrieved for accessing a service;
transmit a request for the credentials over the logical network to a node on the logical network maintaining the credentials for other nodes on the logical network; and
receive the credentials from the node over the logical network.

19. The apparatus of claim 18, wherein to transmit the request, the program instructions direct the apparatus to:
generate one or more packets carrying the request and addressed to a private network address of the node on the logical network;
encapsulate the one or more packets to generate one or more encapsulated packets addressed to a public network address of the node on a public network; and
transmit the one or more encapsulated packets to the public network address over the public network.

20. The apparatus of claim 19, wherein to join the apparatus to the logical network, the program instructions direct the apparatus to:
authenticate the apparatus to a coordination service for the logical network; and
receive the private network address and the public network address from the coordination service.
